(19) United States
(12) Patent Application Publication
(10) Pub. No.: US 2014/0214629 A1
(43) Pub. Date: Jul. 31, 2014

(54) INTERACTION IN A VIRTUAL REALITY ENVIRONMENT

(71) Applicant: HEWLETT-PACKARD DEVELOPMENT COMPANY, L.P., (US)

(72) Inventors: Syed S. AZAM, Tomball, TX (US); William J. BLANKENSHIP, Spring, TX (US); Michael A. PROVENCHER, Cypress, TX (US); Kent E. BIGGS, Tomball, TX (US)

(73) Assignee: HEWLETT-PACKARD DEVELOPMENT COMPANY, L.P., Houston, TX (US)

(21) Appl. No.: 13/754,992

(22) Filed: Jan. 31, 2013

(51) Int. Cl. G06Q 30/06

(52) U.S. Cl. CPC G06Q 30/0643
USPC 705/27.2

(57) ABSTRACT

A three-dimensional virtual reality environment is rendered. A character representation of a user that interacts with the virtual reality environment is rendered. Virtual shops are arranged in the virtual reality environment and virtual products are arranged in the virtual shops based on recorded interaction of the character representation of the user with the virtual reality environment.

### BACKGROUND

Online shopping has grown increasingly popular for both business and personal use as merchants expand the scope of goods and services offered through websites. Generally, with internet based shopping, a shopper accesses a web page provided by a supplier of the merchandise through the Internet, browses or searches a catalog of products and/or services available for purchase, chooses a product and/or service for purchase, selects a delivery option, provides delivery and payment information, and authorizes a purchase transaction. In many ways conventional online shopping is simply an electronic analogue of older mail order and catalog shopping systems.

### BRIEF DESCRIPTION OF THE DRAWINGS

For a detailed description of various examples, reference will now be made to the accompanying drawings in which:

FIG. 1 shows a block diagram of an online shopping system in accordance with principles disclosed herein;

FIG. 2 shows a block diagram for a three-dimensional shopping environment generation system in accordance with principles disclosed herein;

FIG. 3 shows a block diagram of a server for generating an online shopping environment in accordance with principles disclosed herein;

FIG. 4 shows a flow diagram for a method for online shopping in accordance with principles disclosed herein; and

FIGS. 5A-5C show views of a three-dimensional virtual shopping environment generated by the shopping system disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The recitation “based on” is intended to mean “based at least in part on.” Therefore, if X is based on Y, X may be based on Y and any number of other factors.

### DETAILED DESCRIPTION

The following discussion is directed to various implementations of a system and method for interaction in a virtual reality environment and engaging in online commerce. Although one or more of these implementations may be preferred, the implementations disclosed should not be interpreted, or otherwise used, as limiting the scope of the disclosure, including the claims. In addition, one skilled in the art will understand that the following description has broad application, and the discussion of any implementation is illustrative and is not intended to intimate that the scope of the disclosure, including the claims, is limited to that implementation.

While conventional online shopping systems provide a convenient alternative to more traditional “in store” shopping, such systems are subject to various limitations. Merchant-to-shopper and shopper-to-shopper interaction is limited, and is often restricted to chat dialogs and reading reviews. Online social systems may provide a higher degree of user interaction, but shopping systems and social systems, if coupled at all, are only loosely coupled. For example, a social system may provide a link to a shopping system, and when accessed via the link the shopping system lacks the social interaction provided by the social system.

The shopping system disclosed herein provides a three-dimensional (3-D) shopping environment that allows for a more natural shopping experience that includes interaction between shoppers and between shoppers and merchants. In the disclosed shopping system, shoppers and merchants are represented by avatars (an avatar is graphic image of a person corresponding to and controlled by the shopper or merchant) that interact with one another in the shopping environment. The shopping system arranges the shopping environment based on user selection and prior user interaction with the environment. In the shopping environment, the avatars can manipulate products offered for sale in ways that simulate shopper manipulation of products in the physical world. Thus, the shopping system disclosed herein creates a shopping experience that provides the convenience of online shopping while advantageously also providing the social interaction present in in-store shopping.

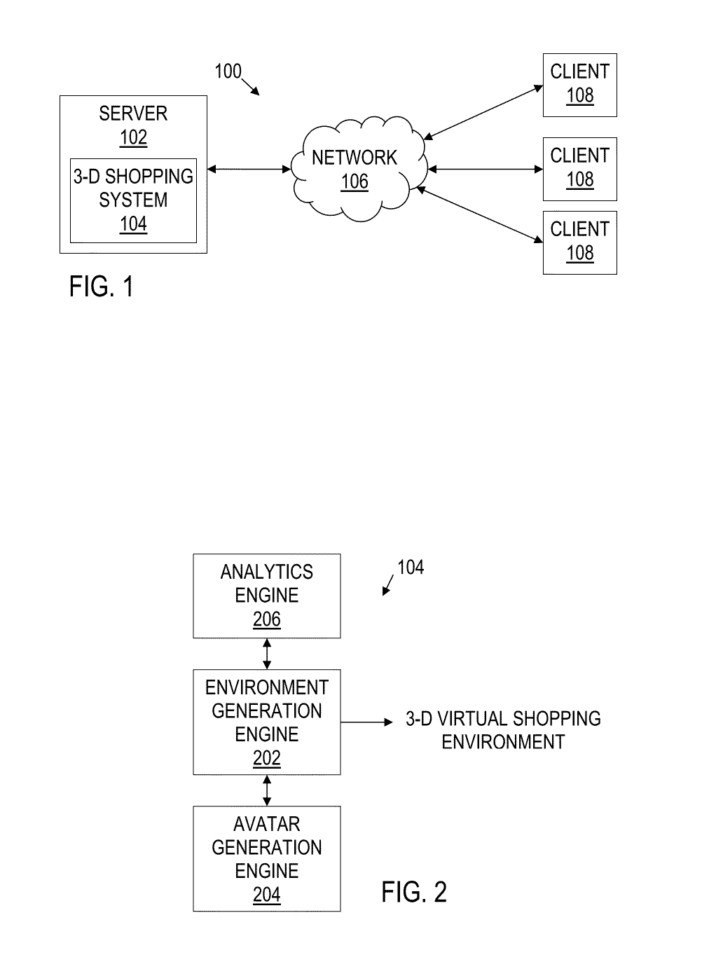

FIG. 1 shows a block diagram of an online shopping system 100 in accordance with principles disclosed herein. The system 100 includes a server 102 and one or more clients 108 that communicate with the server 102 via a network 106. The clients 108 may be computing devices, such as desktop computers, notebook computers, tablet computers, smartphones, or any other computing device suitable for communicating with the server 102 via the network 106. For example, the clients 108 may include display systems, audio systems, user input interfaces, network interfaces, processors, storage, etc. that allow a user of a client 108 to interact with a shopping environment generated by the server 102.

The network 106 coupling the clients 108 and the server 102 may include any available computer networking arrangement, for example, a local area network (“LAN”), a wide area network (“WAN”), a metropolitan area network (“MAN”), the internet, etc. Further, the network 106 may comprise any of a variety of networking technologies, for example, wired, wireless, or optical techniques may be employed. Accordingly, the components of system 100 are not restricted to any particular location or proximity to one another, but rather may be located at any distance from one another.

The server 102 is a computing device, such as a server computer, rackmount computer, etc. that processes requests received from the clients 108 and provides content to the clients 108 on request. The server 102 includes a 3-D shopping system 104 that generates a three-dimensional shopping environment for access by the clients 108. Users of the clients 108 may interact with the shopping environment generated by the server 102 to purchase goods and/or services, conduct meetings (business or social), or engage in other transactions.

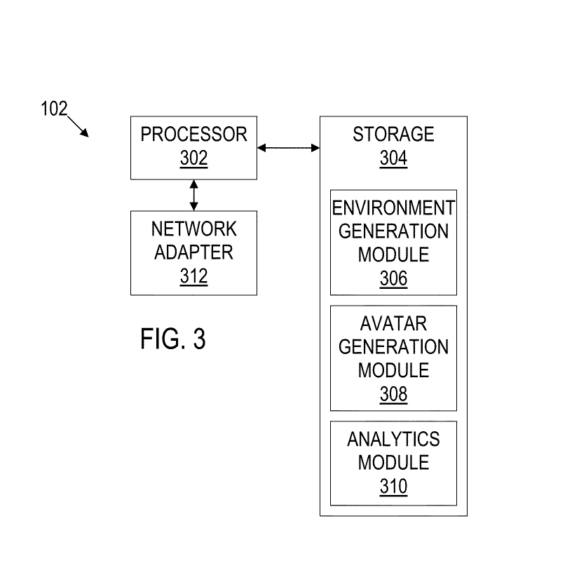

FIG. 2 shows a block diagram for the 3-D shopping system 104 in accordance with principles disclosed herein. The 3-D shopping system 104 includes an environment generation engine 202, an avatar generation engine 204, and an analytics engine 206. The environment generation engine 202 renders a 3-D virtual shopping environment for audio and/or video presentation via the clients 108.

The avatar generation engine 204 renders a character representation, an avatar, corresponding to each user of a client 108. A user of the client 108 may specify the visual characteristics of the avatar. A user controls the avatar to interact with and navigate the 3-D virtual shopping environment, to interact with other shoppers, merchants, and characters in the 3-D virtual shopping environment, and to transact commerce (e.g., purchase products or services).

The analytics engine 206 monitors and records the actions, preferences, trends, and/or habits of each user based on the actions of the avatar of each user in the 3-D virtual shopping environment. The environment generation engine 202 can apply the information recorded by the analytics engine 206 to arrange the shopping environment.

The shopping environment generation engine 202 may generate the 3-D virtual shopping environment as a shopping mall or other structure or arrangement of shops and/or shopping establishments. The 3-D virtual shopping environment generated by the shopping environment generation engine 202 may also include areas designated for social and/or business use, such as conference rooms, movie theaters, arcades, karaoke rooms, etc. where users can meet and engage in business and/or recreational activities via their avatars. Games played in the shopping environment can award prizes, such as discounts or coupons redeemable in the 3-D virtual shopping environment.

The shopping environment generation engine 202 may arrange the 3-D virtual shopping environment based on various factors. For example, the shops may be arranged based on analytic information derived from a user's previous interactions with the 3-D virtual shopping environment (e.g., interactions recorded during a previous or the current session), where the information indicates a user's preference for certain shops or products. Based on such information the shopping environment generation engine 202 may arrange the shopping environment for user convenience and/or to potentially increase sales to the user. The arrangement of the 3-D virtual shopping environment may include arrangement/proximity of shops in the environment, and arrangement/proximity/inclusion of products in the shops. In some implementations, the shopping environment generation engine 202 may arrange the 3-D virtual shopping environment in accordance with a user selected arrangement of shops and/or products. The shopping environment generation engine 202 may provide an interface that allows the user to select or arrange shops and/or products via the client 108.

The shopping environment generation engine 202 may model the 3-D virtual shopping environment to reflect a physical environment, such as a real-world shopping mall. For example, the shopping environment generation engine 202 may determine a geographical location of the client 108 and model the shopping environment to reflect a real world shopping environment in the vicinity of the client 108. For example, a real-world shopping environment considered geographically near a client 108 may be the shopping mall nearest the client 108. A user may also select a real-world shopping environment, such as a mall, as a basis for the 3-D virtual shopping environment. In this way, a user can experience a real-world shopping environment without travel thereto.

In addition to rendering character representations of users that shop and engage in social or business activities in the shopping environment, the avatar generation engine 204 can also generate character representations of vendor associates (e.g., salespersons) and other characters in the shopping environment. A salesperson avatar may be associated with a particular shop and may be controlled by a real-world salesperson via a client 108. Accordingly, real-world shoppers and salespeople may interact in the virtual shopping environment via their avatars. Alternatively, the avatar generation engine 204 may provide for control of a vendor associate avatar by an expert system that manages the avatar in accordance with predetermined rules specified by a merchant, a manufacturer, etc.

To facilitate purchasing decisions, the environment generation engine 202 may generate product representations that closely reflect real-world products. For example, the packaging and operation of the virtual products may reflect the packaging and operation of real-world products. Avatars may interact with and manipulate the virtual products in ways that a user would interact with the products in the real-world. Virtual products may include controls that operate a virtual product in the same way that physical controls operate a real-world product, thereby allowing user to more realistically experience the product in the virtual environment. For example, a virtual automobile may include the same controls as a real-world automobile and allow an avatar to operate the automobile via the virtual controls in the same way that the user would operate the real-world automobile.

In the 3-D virtual shopping environment, purchase of a virtual product or service by an avatar is deemed a purchase of the corresponding real product or service by the user controlling the avatar. The currency exchanged in the 3-D virtual shopping environment may be real currency.

The environment generation engine 202 can present two-dimensional (2-D) or 3-D views of the 3-D virtual shopping environment, as selected by a user, for presentation on a display of a client 108. The 2-D view may comprise a map that allows a user to quickly navigate to a desired location. First person or third person views of the 3-D virtual shopping environment, as selected by the user, may be provided by the environment generation engine 202.

To increase opportunities for revenue generation, the environment generation engine 202 may render video or graphic advertisements (digital signage) on vertical surfaces of the 3-D virtual shopping environment. In some implementations, the digital signage may be selected based on the preferences of the users whose avatars are in the vicinity of the signage.

The environment generation engine 202 may also employ audio to enhance the user's interaction with the virtual environment. Audio systems of a client 108 may include a microphone to capture audio at the client 108 and/or a speaker to generate audio at the client 108. The environment generation engine 202 may blend voice signals captured at a set of clients 108 whose user avatars are within a predetermined proximity to one another in the virtual environment and provide the blended signals to each client 108 of the set of clients 108 for playback. The environment generation engine 202 also mix the voice signals with ambient sound signals representative of sounds present in real-world environment similar to the virtual environment. For example, the environment generation engine 202 may provide ambient sound including air conditioning sounds, fluorescent light hum, background music, background conversation of users proximate each user's avatar, etc.

The environment generation engine 202 may vary the amplitude of sound provided to a client 108 for each sound source based on the distance of the user's avatar from the sound source. Thus, as an avatar's distance from a sound source, such as a speaker providing background music in the virtual environment, increases, the level of sound provided to the client 108 with respect the sound source may decrease. The environment generation engine 202 may also provide controls at each client 108 that allow a user to control sound capture and playback at the client 108. For example, the environment generation engine 202 may allow control over whether sounds captured at a client 108 (e.g., user voice signals) are provided to other clients 108, control over what ambient sound sources (individually or as a group) are played back at client 108, etc.

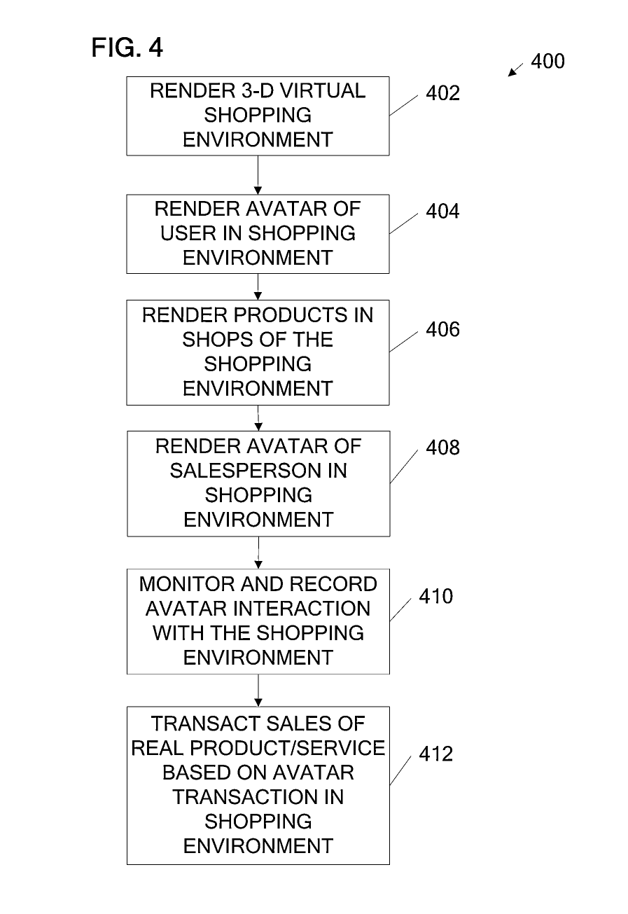

FIG. 3 shows a block diagram of a server 102 for generating an online shopping environment in accordance with principles disclosed herein. The server 102 includes processor(s) 302, storage 304, and a network adapter 312. The network adapter 312 includes a transceiver and other circuitry through which the server 102 communicates with the clients 108 via the network 106. The processor(s) 302 include, for example, a general-purpose microprocessor or other device configured to execute instructions for performing the operations disclosed herein. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The storage 304 stores instructions that are executed by the processor(s) 302 to perform the functions disclosed herein. The storage 304 is a non-transitory computer-readable storage device. A computer-readable storage device may include volatile storage such as random access memory, non-volatile storage (e.g., a hard drive, an optical storage device (e.g., CD or DVD), FLASH storage, read-only-memory), or combinations thereof. Processors execute software instructions. Software instructions alone are incapable of performing a function. Therefore, in the present disclosure, any reference to a function performed by software instructions, or to software instructions performing a function is simply a shorthand means for stating that the function is performed by a processor executing the instructions.

The storage 304 includes an environment generation module 306, an avatar generation module 308, and an analytics module 310. The processor(s) 302 execute instructions contained in the environment generation module 306, the avatar generation module 308, and the analytics module 310 to perform the functions of the environment generation engine 202, the avatar generation engine 204, and the analytics engine 206. Thus, the processor(s) 302 and the environment generation module 306 are constituents of the environment generation engine 202, the processor(s) 302 and the avatar generation module 308 are constituents of the avatar generation engine 204, and the processor(s) 302 and the analytics module 310 are constituents of the analytics engine 206.

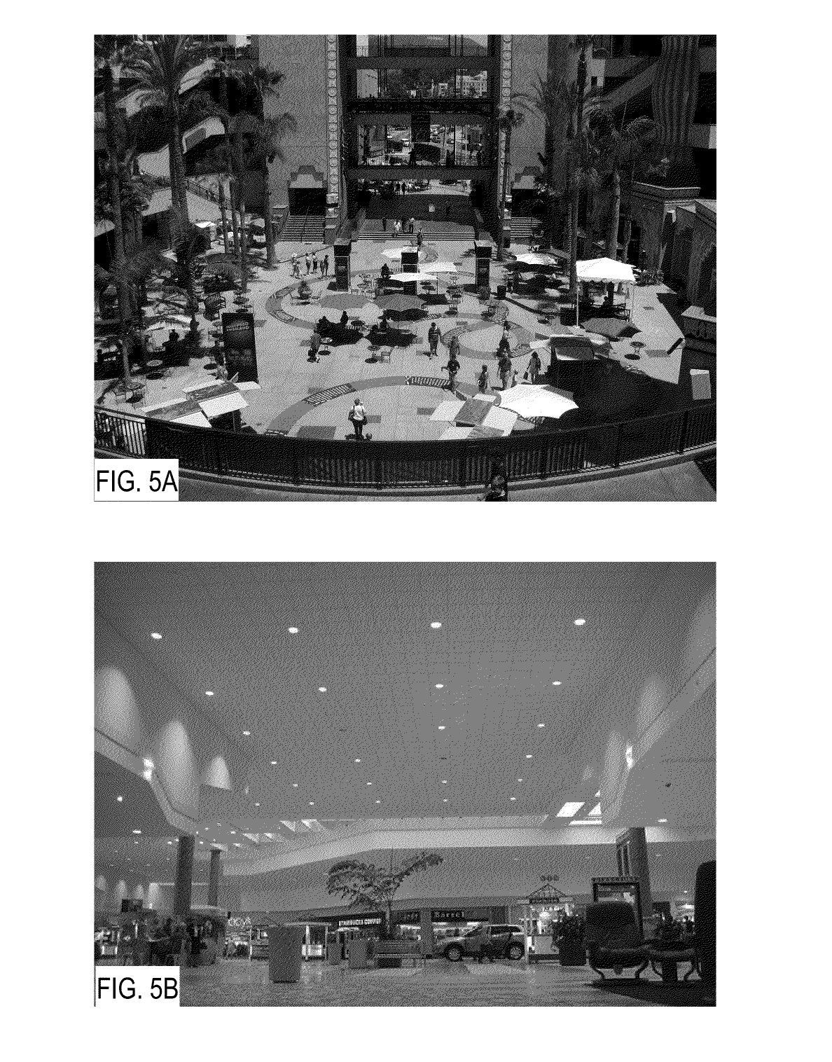

FIG. 4 shows a flow diagram for a method 400 for online shopping in accordance with principles disclosed herein. Though depicted sequentially as a matter of convenience, at least some of the actions shown can be performed in a different order and/or performed in parallel. Additionally, some implementations may perform only some of the actions shown. At least some of the operations of the method 400 can be performed by a processor (e.g., processor(s) 302) executing instructions read from a computer-readable medium (e.g., storage 304).

In block 402, the shopping system 104 renders a 3-D virtual shopping environment at a client 108. The virtual shopping environment may be arranged and/or patterned after a real shopping environment, such as a real shopping mall proximate to the client 108 or selected by a user of the client 108. The shopping system 104 may render shops in the shopping environment in an arrangement that reflects preference of the user of the client 108 based on information extracted from previous user interaction with 3-D virtual shopping environment. Both visual and auditory components of the virtual environment may be generated.

In block 404, the shopping system 104 renders an avatar that is a character representation of the user of the client 108. The user of the client 108 controls the avatar to navigate and interact with the 3-D virtual shopping environment. The shopping environment provides the user with first and/or third person views of the shopping environment. The avatar of the user may interact with other avatars in the shopping environment. For example, the avatar of the user may interact with avatars of other users to determine pricing and availability of products in the shopping environment, to engage in business and/or recreational activities, etc.

In block 406, the shopping system 104 renders virtual products in the shops of the shopping environment. The virtual products may be arranged in the shops in accordance with preference of the user of the client 108 determined based on information extracted from past user interaction with the 3-D virtual shopping environment. The virtual products rendered by the shopping system 104 may be manipulated by the avatar in ways similar to ways real products are manipulated by real shoppers. In some embodiments, the virtual products may be operated by the avatars in the same ways that real products are operated by real shoppers.

In block 408, the shopping system 104 renders an avatar of a salesperson or other vendor associate in a shop of the shopping environment. The avatar of the salesperson may interact with an avatar of a shopper. The avatar of the salesperson may be controlled by a real salesperson via a client 108. The shopping system 104 may also render avatars corresponding to other users and/or characters to interact in the 3-D virtual shopping environment.

In block 410, the shopping system 104 monitors and records interaction of an avatar with the shopping environment. From the recorded interaction the shopping system 104 extracts user preference information that the 3-D virtual shopping system 104 applies to make the 3-D virtual shopping environment more amenable to the user and/or more profitable for the shops. The shopping system 104 may also provide the preference information to vendors (e.g., vendors controlling the shops) to allow the vendors to adjust shop arrangement, product placement, product availability, pricing, etc.

In block 412, the shopping system 104 transacts a sale of a real product or service for a user of a client 108 based on a transaction for a virtual product or service by an avatar controlled by the user of the client 108 in the 3-D virtual shopping environment. Transactions in the 3-D virtual shopping environment may be made using real currencies rather than artificial currencies devised exclusively for use in a virtual world.

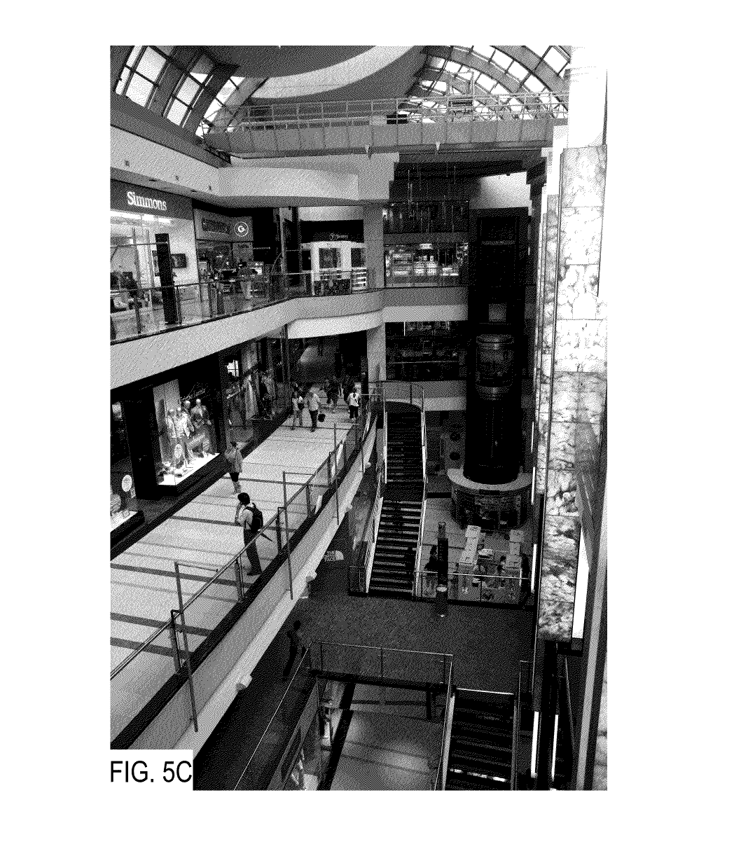

FIGS. 5A-5C show views of the 3-D virtual shopping environment generated by the shopping system 104 disclosed herein. The 3-D virtual shopping environment of FIGS. 5A-5C is rendered as a shopping mall that includes a plurality of shops, each of which includes virtual products that replicate real products. Shopping avatars and salesperson avatars are rendered in the shopping environment. Users interact with the 3-D virtual shopping environment and with each other via the avatars. The avatars are controlled by users of the clients 108. The avatars interact with the shopping environment and manipulate the virtual products in the same ways that real shoppers and salespersons interact with a real shopping environment (and with one another) and manipulate real products when making purchasing decisions.

The virtual environment of FIGS. 5A-5C may also include meeting and/or entertainment venues, such as conference rooms, arcades, virtual movie theaters, etc. A user of a client 108 may employ such facilities provided by the virtual environment to engage in business, social, recreational, or other activities via an avatar.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A system, comprising:
an environment generation engine to render a three-dimensional virtual reality environment; and
an avatar generation engine to render a character representation of a user that interacts with the virtual reality environment;
wherein the environment generation engine is to arrange virtual shops in the virtual reality environment and to arrange virtual products in the virtual shops based on recorded interaction of the character representation of the user with the virtual reality environment.

2. The system of claim 1, wherein the environment generation engine is to render virtual products in the virtual shops such that the products are manipulatable by the character representation of the user.

3. The system of claim 2, wherein the environment generation engine is to render the virtual products as representations of physical products purchasable via the virtual reality environment, and to provide manipulation of the virtual products by the character representation of the user that reflects operation of a corresponding physical product.

4. The system of claim 1, wherein the avatar generator is to render a character representation of a vendor associate corresponding to at least one of the virtual shops to interact with the character representation of the user while the character representation of the user is within the at least one of the virtual shops.

5. The system of claim 4, wherein the character representation of the vendor associate is controllable by an actual vendor associate.

6. The system of claim 1, wherein the avatar generator is to render character representations of a plurality of different users to interact with the character representation of the user in the virtual reality environment.

7. The system of claim 1, wherein the environment generator is to arrange the virtual shops based on selections of shops made by the user.

8. The system of claim 1, wherein the environment generator is to:
determine a geographic location of the user; and
render the virtual reality environment as a representation of an actual shopping environment that is geographically near the user.

9. The system of claim 1, wherein the virtual reality environment includes at least one of a virtual movie theater and a virtual conference room accessible via the character representation of the user.

10. A method, comprising:
rendering, by a processor, a three-dimensional virtual reality environment;
rendering, by the processor, a character representation of a user that interacts with the virtual reality environment;
arranging, by the processor, virtual shops in the virtual reality environment and arranging virtual products in the virtual shops based on recorded interaction of the character representation of the user with the virtual reality environment.

11. The method of claim 10, further comprising rendering the virtual products in the virtual shops such that the products are manipulatable by the character representation of the user in a manner that reflects operation of actual products represented by the virtual products.

12. The method of claim 10, further transacting a purchase of a physical product based on purchase of a virtual product in the virtual reality environment.

13. The method of claim 10, further comprising rendering a character representation of a vendor associate corresponding to at least one of the virtual shops to interact with the character representation of the user while the character representation of the user is within the at least one of the virtual shops; and optionally, causing the character representation of the vendor associate to interact with the character representation of the user based on real-time control provided by an actual vendor associate.

14. The method of claim 10, further comprising arranging the virtual shops based on shop selections provided by the user.

15. The method of claim 10, further comprising:
determining a geographic location of the user; and
rendering the virtual reality environment as a representation of an actual shopping environment located proximate the geographic location of the user.

16. A computer-readable storage device encoded with instructions that when executed by a processor cause the processor to:
render a three-dimensional virtual reality environment;
render a character representation of a user that interacts with the virtual reality environment; and
arrange virtual shops in the virtual reality environment and arrange virtual products in the virtual shops based on recorded interaction of the character representation of the user with the virtual reality environment.

17. The computer readable storage device of claim 16 encoded with instructions that cause the processor to render the virtual products in the shops such that the products are manipulatable by the character representation of the user in a manner that reflects operation of actual products represented by the virtual products.

18. The computer readable storage device of claim 16 encoded with instructions that cause the processor to render a character representation of a vendor associate corresponding at least one of the virtual shops to interact with the character representation of the user while the user is within the at least one of the virtual shops; and provide an interface for controlling, by an actual vendor associate, interaction of the character representation of the vendor associate with the character representation of the user.

19. The computer readable storage device of claim 16 encoded with instructions that cause the processor to arrange the virtual shops based on shop selections provided by the user.

20. The computer readable storage device of claim 16 encoded with instructions that cause the processor to:
determine a geographic location of the user; and
render the virtual reality environment as a representation of an actual shopping environment located proximate the geographic location of the user.
